(19) United States
(12) Patent Application Publication
(10) Pub. No.: US 2004/0172354 A1
(43) Pub. Date: Sep. 2, 2004

(54) Calculator for illustrating investment performance for irregular time periods

(76) Inventor: James Allen Charnley JR., Barrington, RI (US)

Correspondence Address: BARLOW, JOSEPHS & HOLMES, LTD., 101 DYER STREET, 5TH FLOOR, PROVIDENCE, RI, 02903, US

(21) Appl. No.: 10/777,313

(22) Filed: Feb. 12, 2004

Related U.S. Application Data
(60) Provisional application No. 60/446,732, filed on Feb. 13, 2003.

(51) Int. Cl. G06F 17/60

(52) U.S. Cl. 705/36

(57) ABSTRACT

The method is used to calculate investment performance for irregular time periods. The method translates user input of beginning and ending dates for an analysis period into a series of risk-periods of equal length that encompass the entirety of the analysis period. At the beginning or end, or at both ends of an analysis period, there can occur an odd-day period which is a span of days whose length is less than that of the other periods created from the division of an analysis period into risk periods of equal length. The method for including these odd-day periods into a statistic of investment risk and investment performance is to calculate the number of days needed to extend these odd-day periods to a length equal to the other whole risk periods and to calculate a beginning and ending date for these extended periods that can be then used to extract data for a series of daily returns whose average can be computed as a risk-period return for this extended odd-day period.

### CROSS REFERENCE TO RELATED APPLICATIONS

This application claims the benefit of U.S. Provisional Application Serial No. 60/446,732, filed Feb. 13, 2003.

### BACKGROUND OF THE INVENTION

The present invention relates to the performance of an investment or an investment portfolio. More specifically, the present invention relates to a calculator for illustrating the relative investment performance of such investment or investment portfolio over time.

There exist numerous commercial services designed to compare the performance of an investment or investment portfolio to the performance of various investment indices and benchmarks. These services compute investment performance as the tradeoff between investment returns and investment risk as tabulated by the following (2) statistics: 1) ‘investment returns’, calculated as either the arithmetic or the geometric average of a contiguous series of periodic investment returns (‘average returns’); and 2) ‘investment risk’, calculated as the volatility of those periodic returns, as represented either by their variance around their average (‘standard deviation of periodic returns’) or their degree of covariance with a series of periodic returns produced by a index or other investment benchmark (‘beta’).

A drawback of these services is their inability to calculate investment risk for irregular time-periods. A series of periodic returns used to calculate investment risk are tabulated in terms of calendar-based time divisions—daily, weekly, monthly, quarterly, annual or multiple-12-month periods. The returns generated in each of these ‘risk periods’ is a ‘whole-period’ return—a statistic measuring the volatility of these returns must be made from periods of equal length. Because of their calendar orientation, these risk-periods commonly begin and end on a standard calendar date—Monday to Sunday for a weekly series, the first day to the last day of the month for a monthly series, January 1 and December 31 for an annual series.

The issue for investors wishing to make a measurement of investment risk or performance for the actual time period over which they hold an investment or investment portfolio—‘analysis period’—is that this investment or investment portfolio may not necessarily have been acquired on a Monday or the first day of the month, quarter or year—the ‘analysis-period start-date’ may be at odds with calendar-based time divisions. Of greater import, the moment in time at which these investors may want to evaluate performance of their investment or portfolio may not conform to these calendar-period-ending dates.

These ‘odd-days’ create irregular time periods that cannot be accommodated in existing methods for calculating investment risk and investment performance. With the onset of on-line investing, investors have much more flexibility in initiating an investment acquisition, and unlimited access for viewing the current status of those acquisitions. This flexibility creates a demand for calculating the current performance status of an investment portfolio—a demand that is frustrated by a pervasive odd-days problem—and a need for a method to account for irregular time-periods in investment performance analysis.

Investors desiring to evaluate the performance of an investment or investment portfolio commonly use indices as benchmark measures.

Indices are constructed from populations of investments held as a portfolio. The combined market value of the portfolio is calculated and a ‘benchmark initial level’ is set for this value at date of benchmark initiation —usually 100. The portfolio value is then recalculated over a series of short, consecutive time periods—usually daily—as the change in combined market value for the investments within the portfolio plus any distributions to or additions from shareholders during the previous day period. The change in portfolio value equals the ‘investment return’ for the benchmark. The average of a contiguous series of these periodic returns is the benchmark's “average returns”. The volatility of these periodic returns around their average or their covariance to the volatility of returns for another benchmark measure is ‘investment risk’, and the tradeoff of this investment return and investment risk—usually denominated as the investment return as a function of investment risk—is the ‘investment performance’ of the benchmark measure.

Examples of published indices for the primary-securities market are the NASD Market Index, S&P500 Market Index, Lehman Brothers Aggregate Bond Market Index, Yield on the 90-day Treasury Bill, Morgan Stanley Country Index for Europe, Asia and the Far East (MSCI-EAFE). Examples of indices for secondary-securities markets, such as the mutual funds market, are the Water Street Market-Sector Indices, Morningstar Class Averages and Lipper Fund Averages.

Likewise, calculations of daily returns for individual publicly-traded investments are available to investors. Although not set at a common initial benchmark level, as are the indices, the daily return of an investment has the same basis—the change in its market value plus any distributions to or additions from shareholders during the previous day period. Like the indices, a contiguous series of an investment's daily returns can be aggregated into longer period measures of investment return and investment risk.

The statistic of investment return for indices and investments is calculated as either the arithmetic or geometric average of a series of daily returns (‘average return’) and can be aggregated for analysis periods of variable length—the only qualifying factor to the calculation being that the series of daily returns be contiguous and complete. For purposes of conformity in comparing statistics from different-sized analysis periods, this analysis-period average is commonly ‘annualized’—extrapolated as an average for a series of 12-month periods (‘average annual return’). It is also common to calculate calendar-based averages—year-to-date average return, quarter-to-date return.

The statistic of investment risk is calculated as either the variance of risk-period returns around an analysis-period average (‘standard deviation of periodic returns’), or as the covariance of risk-period returns with those risk-period returns of another investment or performance index (‘beta’). Risk-periods are subdivisions of an analysis period and by construction are necessarily of equal length—either in nominal terms (calendar months, calendar quarters, calendar years) or actual terms (7-day, 30 day, 360-day periods). It is common to divide analysis periods into risk-periods that conform to an investor's tolerance for risk as exhibited by their tolerance for periodic volatility, the qualifying factor being that such a division of an analysis period creates at least (3) risk-periods with which to generate a risk statistic.

Investment risk is calculated in terms of both ‘prior-period risk’—the volatility of periodic returns for a time-period previous to the time period used to calculate of average returns—and ‘contemporaneous risk’—the volatility of the periodic returns used to generate the statistic of average return for an analysis period. Either basis for calculating risk has its shortcomings, but both are in wide use. The process of the present invention corrects for deficiencies in calculating investment risk and performance for irregular periods encountered for either case.

If an analysis period cannot be divided evenly into equal-sized risk-periods, there occurs the issue ‘odd days’—one or more series of daily returns for portions of that analysis period which cannot be made into an equal-sized risk periods (‘odd-day periods’). This is a problem for calculating investment risk, as well as for calculating investment performance, since investment risk is a component of the calculation of investment performance.

The common solution to the odd-day-period issue is to ignore these odd-day periods and to calculate investment return, risk and performance for only that portion of an analysis period for which there exists a population of whole risk-periods. The period used for these calculations is truncated to a series of risk-periods beginning at the first full risk-period and ending at the completion of the last full risk-period in the analysis period.

Thus, there are serious problems associated with prior art methods of calculating risk requiring an efficient yet effective solution. The issue of irregular analysis periods does not exist for an investor concerned only with the daily volatility of their investments, since the calculation of daily volatility does not entail odd-day periods. Typically, investors' tolerance for risk extends for longer periods of volatility than day-to-day and the demand exists for measurements of risk that encompass longer time periods—statistics of weekly, monthly, quarterly and yearly volatility. Existing processes for calculating these longer risk measures commonly employ regular calendar divisions in formulating risk-periods—the beginning and end of calendar weeks, the beginning and end of calendar months, beginning and end of calendar quarters, divisions of six-month calendar periods, divisions of 12 month calendar periods, annual (calendar year) divisions, 5-year calendar periods, 10-year calendar periods, etc.

Existing processes to report investment performance statistics to investors use these regular-period numbers. An investor acquiring an investment or investment portfolio on Jan. 10, 2002 and holding it until Aug. 20, 2002 has no way of comparing its contemporaneous performance over the entirety of that 222-day span—other than as a partial analysis period based on a series of (31) seven-day risk periods ending August 15 or six monthly risk-period beginning February 1 and ending July 31, or based on a two-quarterly risk-periods beginning March land ending Jun. 30, 2002. For a comparison based on historical risk, he is limited to a series of weekly risk periods ending Jan. 4, 2002 or monthly, quarterly or annual risk-periods ending Dec. 31, 2001.

Much can happen over these neglected odd-day periods. For example, the Dow Jones Industrial Average dropped over (−) 900 points (−5.6% loss in value) between Dec. 31, 2001 and Jan. 10, 2002—and gained over 300 points (+3.4% gain value) between Aug. 1 and Aug. 20, 2002.

In view of the foregoing, there is a demand for method of calculating risk that accurately process investment performance statistics over large time periods. There is a particular demand for such a method to include odd-day periods in a calendar-based analysis. There is a demand for a method of calculating risk that can accurately and fully analyze and report an irregular risk period.

### SUMMARY OF THE INVENTION

The present invention preserves the advantages of prior art for calculators of investment risk and performance. In addition, the improved calculation method of the present invention provides new advantages not found in currently known calculators and methods and overcomes many disadvantages of such currently available calculators and methods.

The invention is a calculator of investment performance and investment risk for irregular time-periods. It utilizes third-party statistics of daily returns for investments and investment performance indices. These daily statistics are aggregated into a series of periodic returns for risk periods of equal length that encompass the whole of an analysis period. The method for calculating the number, beginning-date and ending date of these risk-periods is the unique process of this invention.

The invention is generally directed to the novel and unique method of comparing investment performance over irregular time periods. The method is used to calculate investment performance for irregular time periods. The method to translates user input of beginning and ending dates for an analysis period into a series of risk-periods of equal length that encompass the entirety of the analysis period. At the beginning or end, or at both ends of an analysis period, there can occur an odd-day period which is a span of days whose length is less than that of the other periods created from the division of an analysis period into risk periods of equal length. The method includes these odd-day periods into a statistic of investment risk and investment performance by calculating the number of days needed to extend these odd-day periods to a length equal to the other whole risk periods, and by identifying a beginning and ending date for these extended periods that can be then used to extract data for a series of daily returns whose average can be computed as a risk-period return for this extended odd-day period.

Accordingly, it is a primary object of the instant invention to be a method of calculating investment risk over irregular time periods.

Another object of the instant invention is to provide a method of calculating investment risk that is more accurate than prior art methods.

Still further, an object of the instant invention is to provide a method of calculating investment risk that more accurately determines investment performance than prior art methods.

It is yet another object of the present invention to provide a method of calculating investment risk that has the ability to compare the daily change in portfolio condition to a series of market and performance benchmarks in terms of investment performance.

A further object of the present invention is to provide a method of calculating risk that provides the investor more flexibility in modeling different risk horizons as their risk tolerance changes.

### BRIEF DESCRIPTION OF THE DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a database of daily values for market and performance indices;

FIG. 2 is a database of daily values for a population of investment alternatives;

FIG. 3 is an information worksheet for receiving and identifying a user's investment or investment portfolio;

FIG. 4 is a flow chart illustrating the calculation of investment risk for a series of calendar-length risk periods with a variable analysis-period ending date in accordance with the present invention;

FIG. 5 is a flow chart illustrating the calculation of investment risk for a series of constant-length risk periods with a variable analysis-period ending date;

FIG. 6 is a flow chart illustrating the calculation of investment risk for a series of calendar-length risk periods that allows the user to select for risk-period ending dates that correspond to calendar ending dates;

FIG. 7 is a flow chart illustrating the calculation of investment risk for an analysis-period of a variable ending-date, made from calendar-length risk periods and ending prior to the beginning of the current analysis-period;

FIG. 8 is a flow chart illustrating the calculation of investment risk for an analysis-period of a variable ending-date, made from constant-length risk periods and ending prior to the beginning of the current analysis-period; and

FIG. 9 is a flow chart illustrating the calculation of investment risk for an analysis-period of a calendar-date ending date, calendar-length risk periods and ending prior to the beginning of the current analysis-period.

### DETAILED DESCRIPTION OF THE PREFERRED EMBODIMENT

This process is an interactive calculator, delivered either through the internet, daily computer updates or daily print publication, that will provide an investor the method for comparing investment performance over irregular time periods—for example, a 222-day period spanning Jan. 10, 2002 and Aug. 20, 2002. The feature that makes this process unique is a process to calculate investment risk over these irregular periods. There exist commercial services for calculating investment returns, but not investment risk over irregular time periods. Without this calculation of investment risk, there exists no calculation of investment performance for these irregular analysis periods.

This invention is to be used as the basis for a service provided investors for evaluating the performance of their investment portfolios. With the advent of on-line brokerage and investment account reporting, it has become usual for investors to be capable of acquiring investments and checking their account balance and account appreciation (investment return) over daily time-periods. There exist on-line systems that also report a period-to-date investment return for selected indices as a comparative measure. My process provides the additional capability for investors to compare the daily change in portfolio condition to a series of market and performance benchmarks in terms of investment performance. The process encompasses an additional feature in the flexibility it provides the investor in naming an irregular start-date for the comparison. The capability of calculating investment risk over irregular time periods also provides the flexibility for the investor to easily model different risk horizons as changes in their financial situation or market conditions cause a change in their risk tolerance.

This invention is a process that computes comparative statistics of investment performance over irregular time-periods. These statistics include investment return, investment risk and investment performance. It operates from (3) databases—one built of performance statistics for popular and commonly-used benchmark measures, another of performance statistics for the population of available investments and a third created by the user. The process is activated by user input into this third database—input that includes identification of the beginning and ending dates for an analysis-period and a listing of the investments to be analyzed, as well as, the user's preferences regarding choice of benchmark measures, performance statistics to be analyzed and tolerance for risk.

The key innovation is a method to translate the user input of beginning and ending dates for an analysis period into a series of risk-periods of equal length that encompass the entirety of the analysis period. The method of the present invention, in its basic form, is implemented as the process outlined below.

At the beginning or end, or at both ends of an analysis period, there can occur an odd-day period—a span of days whose length is less than that of the other periods created from the division of an analysis period into risk periods of equal length. My method of including these odd-day periods into a statistic of investment risk and investment performance is to calculate the number of days needed to extend these odd-day periods to a length equal to the other whole risk periods and to calculate a beginning and ending date for these extended periods that can be then used to extract data for a series of daily returns whose average can be computed as a risk-period return for this extended odd-day period.

A number of variants to this process are also set forth below. As will be discussed, the variant to be used depends on the choice of periodicity and risk-measurement conventions chosen by the user.

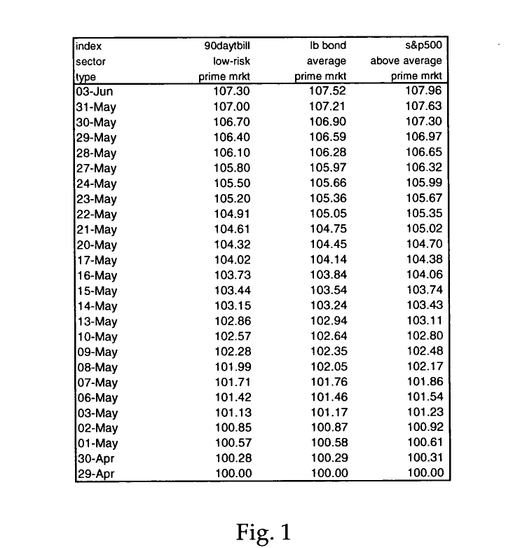

Referring first to FIG. 1, the daily values for market and performance indices must be acquired and recorded in a database.

For the popular market indices, the daily change in benchmark value is recorded and published in a variety of formats and by a number of vendors. For other performance indices whose daily data may not be in the public domain, a negotiated process for acquiring the data will need to be instituted.

A database will be created and maintained that includes the benchmark name, daily value and all other identification data necessary to designate the benchmark by standard industry identification procedures and by association to specific market-sector populations of securities and investment management objectives.

FIG. 1 illustrates such a database with the first (3) primary-securities market indices added. Additional database columns may be included for other primary-securities market indices, mutual fund market (secondary market) indices of investment objective, market category and market-sector populations, as well as, other indices and benchmarks, such as the Water Street Market-Sector Manager Indices.

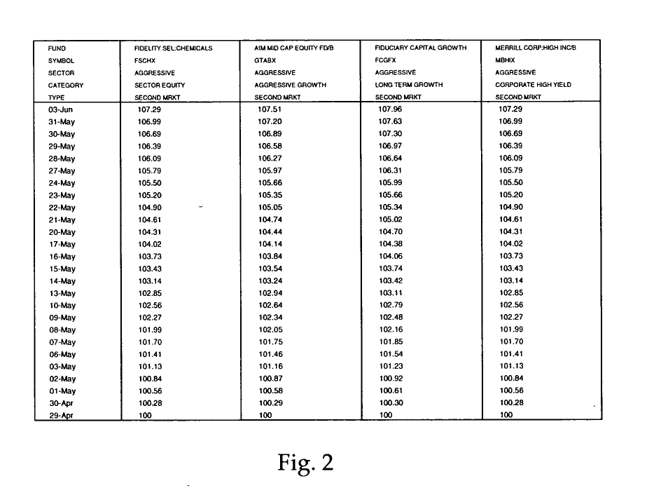

As will be discussed in connection with FIG. 2, daily values for a population of investment alternatives must then be acquired and recorded in database. A second database will be built with data acquired from other sources consisting of the daily total returns from a population of domestic and foreign registered securities, as well as collective and common trusts, investment accounts, insurance company separate accounts, and other financial investments exempt from registration requirements.

This database will include the investment alternative's daily value and all other identification data necessary to designate the investment by standard industry identification procedures and by association to specific market-sector populations of securities and investment management objectives.

For consistency sake, these daily returns will be translated to an ‘index-basis’, their beginning values marked to par=100 and the incremental changes in total return calculated from this basis. FIG. 2 illustrates such a database for three (3) mutual funds, as an example.

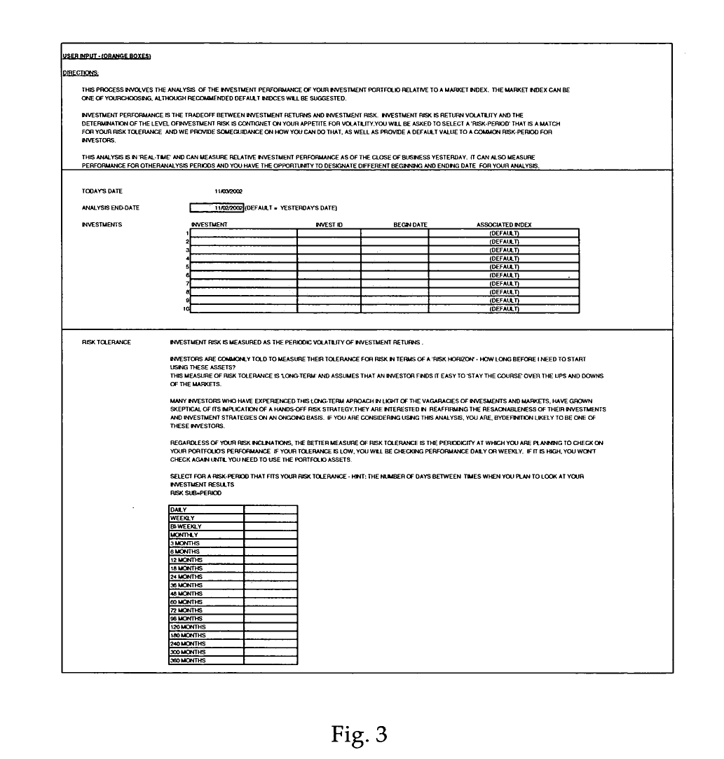

Referring now to FIG. 3, information on the identity of a user's investment or investment portfolio is received. The form illustrated in FIG. 3 facilitates the gathering and recording of such information. The information gathered is formed to create a third database created from user input. The user will be asked to identify the analysis investment population, a beginning and ending date for the analysis period, risk tolerance preferences and risk perspective using a worksheet or computer screen formatted as shown in FIG. 3.

Next, the average investment return generated by the market and performance indices for the analysis period is calculated according to known methods in the art. The user will be asked to input a start and ending date for the time period to be analyzed and the number of days between the two dates will be computed (‘analysis period’).

The average investment return for the analysis period for each investment and investment portfolio listed will be calculated via methods standard to the industry. That is to say that investment return will be calculated as the geometric average of the periodic daily returns over the term of the analysis period as follows:

(((100*sum(1+[daily appreciation in index value]/100))/100)\hat{ }(1/[term])−1)*100

The term “[term]” used in the calculation is the number of days in the analysis period divided by the number of days in a year—365/366 days. This term calculation results in the computation of an annualized average return for an irregular time period as specified by the user. It is common to present average return statistics as ‘annualized’ numbers.

The user will be presented with an option to recalculate the average return as a ‘gross return’—an non-annualized number computed by omitting the 356/366 day divisor from the average return calculation.

Also the option will be given to calculate an arithmetic average of the daily periodic returns and to annualize that number.

In accordance with known methods in the art, the average return for the user's investment or investment portfolio is calculated. More specifically, average return for the investments identified by the user is preferably calculated using the same methodology as for the index measures (point (4) above).

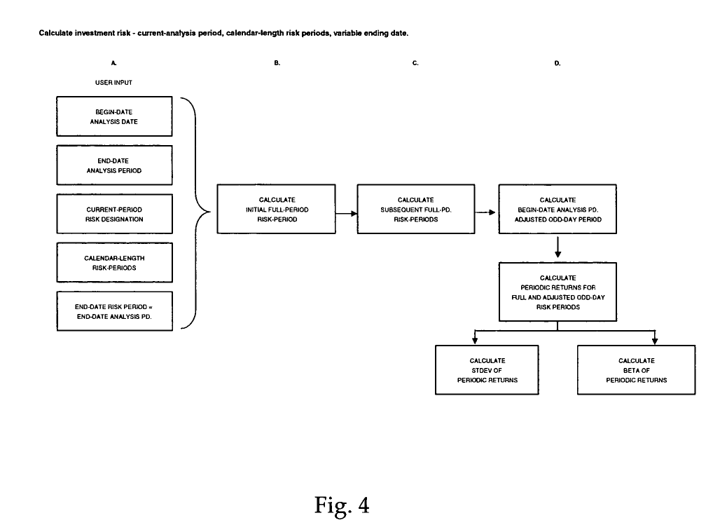

The foregoing calculation of the investment risk can be carried out in many different ways using alternative methods. By way of example, as shown in FIG. 4, investment risk is calculated using the current-analysis period, calendar-length risk periods with a variable ending date.

There exist variations in the format of the risk-periods used to determine investment risk. The user will be provided the default of current-analysis period, calendar-length risk periods whose ending dates are contingent on the ending date of the analysis. The steps for this calculation are as follows:

a. Receive user input as to risk-period designation (weekly, monthly, 3-month, etc.), ending and starting date of analysis, and determination to calculate risk from volatility of analysis-period periodic returns.

b. Count backward from the ending date of the analysis period the number of days in designated risk-period (weekly=7 days, monthly=28,29,30 or 31 days, 3-month=89, 90, 91 or 92 days) to mark beginning date of end-date risk-period (most-current risk period within the analysis period).

c. Continue to count backward to mark each successive ‘full-period’ risk period until the analysis-period beginning date is reached. The number of days for each calendar-length risk period is determined by the days in the calendar-length risk period in which each risk-period ending date resides.

d. When the calculated risk-period beginning at analysis-period beginning date is found to be less than a full-period, then it is an ‘odd-day period’. Beginning at the beginning-date for the analysis-period, count forward the number of days for a full-period risk period. This is the ‘adjusted-odd-day period’.

e. Calculate a series of risk-period investment returns using the population of full-period and adjusted-odd-day risk—periods within the analysis period, each risk-period return calculated as the annualized geometric average of its daily investment returns (see step 4 and 5).

f. Calculate either the standard deviation of periodic returns or beta for the analysis period using this series.

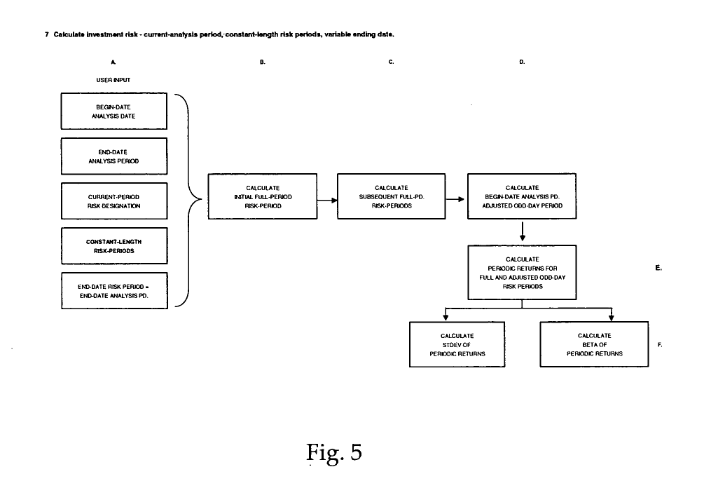

Another alternative method is shown in FIG. 5 where the investment risk is calculated with a current-analysis period, constant-length risk period with a variable ending date.

This is a variation of the alternative method shown in FIG. 4 whereby the customer selects for constant-length risk periods (15-day, 30-day, 90-day, etc.). The steps for this calculation are as follows:

a. Receive user input as to risk-period designation (15-day, 30-day, 90-day, etc.), ending and starting date of analysis, and determination to calculate risk from volatility of analysis-period periodic returns.

b. Count backward from analysis-period ending date the number of days in the designated risk-period (15, 30, 90 days, e.g.) to mark the beginning date of the end-date risk-period (most-current risk period within the analysis period).

c. Continue to count backward to mark each successive ‘full-period’ risk period until the analysis-period beginning date is reached. The number of days for each full risk-period division will be equal.

d. When the calculated risk-period beginning at analysis-period beginning date is found to be less than a full-period, then it is an ‘odd-day period’. Beginning at beginning-date for the analysis-period, count forward the number of days for a full-period risk period. This is the ‘adjusted-odd-day period’.

e. Calculate a series comprised of the periodic-returns for each full-period and adjusted-odd-day period as an annualized geometric average made from the daily returns within each risk period (see step 4 and 5).

f. Calculate either the standard deviation of periodic returns or beta for the analysis period using this series.

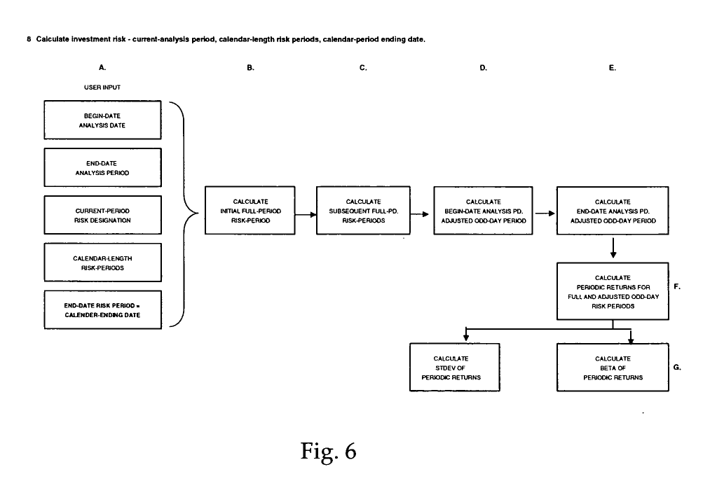

Yet another alternative method of calculating investment risk is shown in FIG. 6. In this alternative, the investment risk is calculated with the current-analysis period, calendar-length risk periods and a calendar-period ending date.

This variation allows the user to select for risk-period ending dates that correspond to calendar-ending dates (week's-end, month-end, year-end). The steps for this calculation are as follows:

a. Receive user input as to risk-period designation (weekly, monthly, 3-month, etc.), ending and starting date of analysis, and determination to calculate risk from volatility of analysis-period periodic returns. Receive user input as to risk-period calendar-period ending dates—e.g., week's end, month-end, year-end).

b. Count backward from the risk-period calendar-period ending date closest to analysis-period ending date by the selected calendar division (week, month, year) to mark the ending dates of each successive ‘full-period’ risk period.

c. Continue to count backward to mark each successive ‘full-period’ risk period until the analysis-period beginning date is reached. The number of days for each variable-length division is determined by the days in the calendar month or year in which each ending date resides.

d. When the calculated risk-period beginning at analysis-period beginning date is found to be less than a full-period, then it is an ‘odd-day period’. Beginning at beginning-date for analysis-period, count forward the number of days for a full-period risk period. This is the ‘adjusted-odd-day period’.

e. Count forward from the risk-period ending date closest to the analysis-period ending date to analysis-period ending date. This constitutes a second ‘odd-days period’. Beginning at analysis-period ending date, count backwards the number of days for a full-period risk period. This is the ‘adjusted second-odd-day period’. The number of days for this period is determined is the number of days in the calendar month or year in which the analysis-period ending date resides.

f. Calculate a series comprised of the periodic-returns for each full-period and each adjusted-odd-day period as annualized geometric averages made from the daily returns within each risk-period (see step 4 and 5).

g. Calculate either the standard deviation of periodic returns or beta for the analysis period using this series.

Another embodiment calculates investment risk with a prior-period-analysis period, a calendar-length risk period and a variable ending date.

The (3) variations for calculating risk-periods for the current-period analysis period can be adapted to work for an analysis of investment risk involving a period prior to the current analysis period. The most common usage of this capability is to compare the risk of an investment as it appeared prior to selection with the investment returns generated after selection.

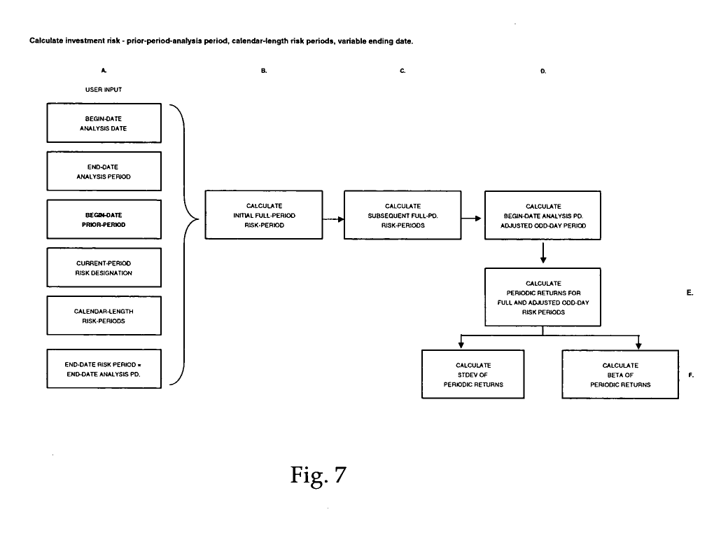

The process for this calculation for calendar-length risk periods and a variable-analysis-period ending date is illustrated in FIG. 7.

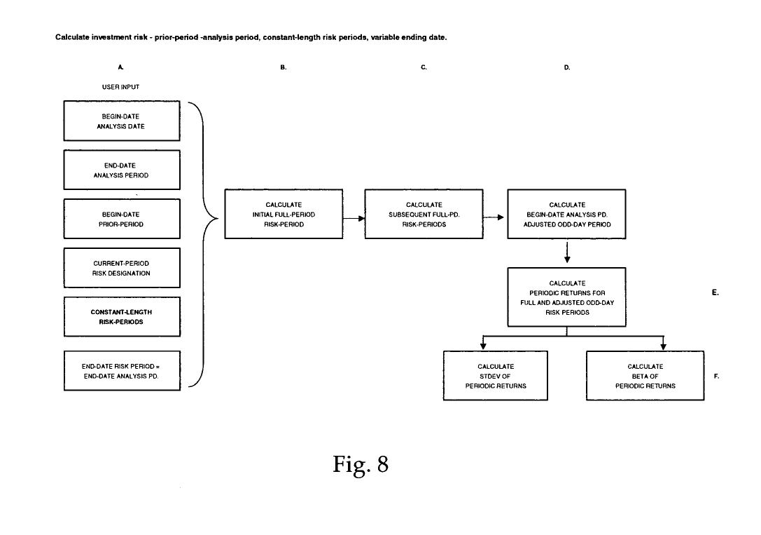

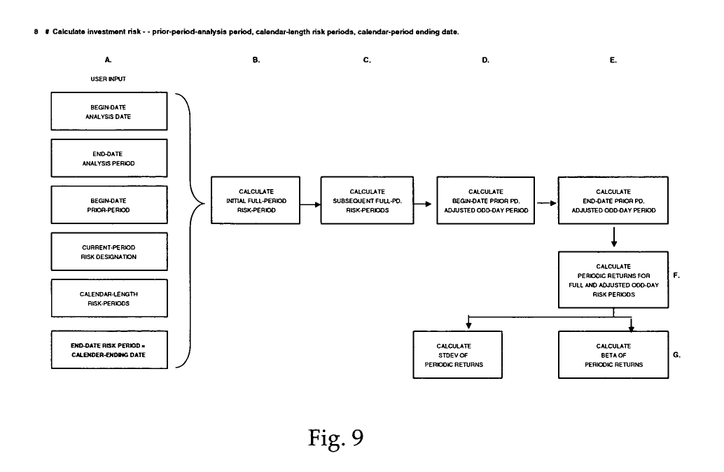

Another alternative process is shown in FIG. 8 which is a method of calculating investment risk for constant-length risk periods and a variable-analysis-period ending date. FIG. 9 illustrates another method of calculating investment risk for calendar-length risk periods and a calendar-period ending for risk periods.

It would be appreciated by those skilled in the art that various changes and modifications can be made to the illustrated embodiments without departing from the spirit of the present invention. All such modifications and changes areintended to be covered by the appended claims.

What is claimed is:

1. A method of comparing investment performance over irregular time periods, comprising the steps of:
selecting an analysis period having a beginning date and an ending date;
dividing the analysis period into a series of contiguous risk-periods of equal length in days;
identifying an odd-day period adjacent to one of the risk periods of equal length;
calculating the number of days required to extend the odd-day period to the equal length of the equal risk-periods forming an extended period;
determining a beginning date and an ending date for the extended period;
calculating a series of daily returns for the extended period whose average can be computed as a risk-period return; and
determining investment risk for the analysis period.

2. The method of claim 1, further comprising the steps of:
creating a database of benchmark data;
creating a database of market-sector populations;
creating a database of input data of a user; the input data of a user including the beginning date and ending date of the analysis period, investment population, risk tolerance preferences and risk perspective;
calculating investment return for the analysis period.

3. The method of claim 2, wherein the step of calculating investment return is the geometric average of the periodic daily returns over the term of the analysis period using the following formula:
(((100*sum(1+[daily appreciation in index value]/100))/100)\hat{ }(1/[term])−1)*100

4. The method of claim 1, further comprising the steps of:
receiving user input as to risk-period designation and ending and starting dates of the analysis period;
calculating risk from volatility of analysis-period periodic returns;
counting backward from the analysis-period ending date the number of days in the designated risk-period;
marking the beginning date of end-date risk-period;
continuing to count backward and marking each successive ‘full-period’ risk period until reaching beginning date of the analysis period;
determining the number of days for each calendar-length risk-period by the days in the calendar-length risk-period in which each risk-period ending date resides;
identifying an odd-day period when a risk-period beginning at analysis-period beginning date is found to be less than a full-period;
counting forward the number of days for a full-period risk period starting at the beginning-date for the analysis-period defining an adjusted-odd-day period;
calculating a series comprised of the periodic-return from the daily returns for each full-period and adjusted-odd-day risk-period as an annualized geometric average; and
calculating the standard deviation of periodic returns for the analysis period using the series.

5. The method of claim, further comprising the steps of:
receiving user input as to risk-period designation and ending and starting dates of the analysis period;
calculating risk from the volatility of analysis-period periodic returns;
counting backward from the analysis-period ending date the number of days in designated risk-period;
marking the beginning date of the analysis-period end-date risk-period;
continuing to count backward and marking each successive ‘full-period’ risk period until reaching the beginning date of the analysis period;
determining the number of days for each calendar-length risk-period by the days in the calendar-length risk period in which each risk-period ending date resides;
identifying an odd-day period when a risk-period beginning at analysis-period beginning date is found to be less than a full-period;
counting forward the number of days for a full-period risk period starting at the beginning-date for the analysis-period defining an adjusted-odd-day period;
calculating a series comprised of the periodic-return from the daily returns for each full-period and adjusted-odd-day risk-period as an annualized geometric average; and
calculating the beta for the analysis period using the series.

6. The method of claim 1, further comprising the steps of:
receiving user input as to risk-period designation and ending and starting dates of the analysis period;
calculating risk from the volatility of analysis-period periodic returns;
counting backward from the analysis-period ending date the number of days in designated risk-period;
marking the beginning date of the analysis-period end-date risk-period;
continuing to count backward and marking each successive ‘full-period’ risk period until reaching beginning date of the analysis period; the number of days in a risk period being equal;
identifying an odd-day period when a risk-period beginning at analysis-period beginning date is found to be less than a full-period counting forward the number of days for a full-period risk period starting at the beginning-date for the analysis-period defining an adjusted-odd-day period;
calculating a series comprised of the periodic-return from the daily returns for each full-period and adjusted-odd-day risk-period as an annualized geometric average; and
calculating the standard deviation of periodic returns for the analysis period using the series.

7. The method of claim 1, further comprising the steps of:
receiving user input as to risk-period designation and ending and starting dates of analysis period;
calculating risk from the volatility of analysis-period periodic returns;
counting backward from the analysis-period ending date the number of days in designated risk-period;
marking the beginning date of end-date risk-period;
continuing to count backward and marking each successive ‘full-period’ risk period until reaching beginning date of the analysis period; the number of days in a risk period being equal;
identifying an odd-day period when a risk-period beginning at analysis-period beginning date is found to be less than a full-period is determined;
counting forward the number of days for a full-period risk period starting at the beginning-date for the analysis-period defining an adjusted-odd-day period;
calculating a series comprised of the periodic-return from the daily returns for each full-period and adjusted-odd-day risk-period as an annualized geometric average; and
calculating the beta for the analysis period using the series.

8. The method of claim 1, further comprising the steps of:
receiving user input as to risk-period designation and ending and starting dates of analysis period;
calculating risk from the volatility of analysis-period periodic returns;
receiving user input as to their preference for calendar-date risk-period ending dates;
counting backward from the risk-period calendar-date ending date that is closest to the analysis period ending date by a selected calendar division;
marking the beginning date of each successive “full-period” risk-period;
continuing to count backward and marking each successive ‘full-period’ risk period until reaching beginning date of the analysis period;
determining the number of days for each variable-length risk-period by the days in a variable-length risk-period in which each risk-period ending date resides;
identifying a first odd-day period when a risk-period beginning at the analysis-period beginning date is found to be less than a full-period;
counting forward the number of days for a full-period risk period starting at the beginning-date for the analysis-period defining a first adjusted-odd-day period;
counting forward from the risk-period ending date closest to the analysis-period ending date to the analysis period ending to analysis period ending date defining a second odd-day period;
counting backwards from the analysis-period ending date the number of days for a full risk period defining a second adjusted odd-day period; the second adjusted odd-day period being determined by the number of days in the calendar period in which the analysis-period ending date resides;
calculating a series comprised of the periodic-return from the daily returns for each full-period and each adjusted-odd-day risk-period as an annualized geometric average; and
calculating the standard deviation of periodic returns for the analysis period using the series.

9. The method of claim 1, further comprising the steps of:
receiving user input as to risk-period designation and ending and starting dates of analysis period;
calculating risk from the volatility of analysis-period periodic returns;
receiving user input as to the ir preference for calendar-date risk-period ending dates;
counting backward from risk-period calendar-date ending date that is closest to the analysis period ending date by a selected calendar division;
marking the beginning date of each successive “full-period” risk-period;
continuing to count backward and marking each successive ‘full-period’ risk period until reaching beginning date of the analysis period;
determining the number of days for each variable-length risk-period by the days in variable-length risk-period in which each ending date resides;
identifying a first odd-day period when a risk-period beginning at the analysis-period beginning date is found to be less than a full-period is determined;
counting forward the number of days for a full-period risk period starting at the beginning-date for the analysis-period defining a first adjusted-odd-day period;
counting forward from the risk-period ending date closest to the analysis-period ending date to the analysis period ending to analysis period ending date defining a second odd-day period;
counting backwards from the analysis-period ending date the number of days for a full risk period defining a second adjusted odd-day period; the second adjusted odd-day period being determined by the number of days in the calendar period in which the analysis-period ending date resides;
calculating a series comprised of the periodic-return from the daily returns for each full-period and each adjusted-odd-day reisk-period as an annualized geometric average; and
calculating the beta for the analysis period using the series.
